(19) United States
(12) Patent Application Publication
(10) Pub. No.: US 2014/0304039 A1
(43) Pub. Date: Oct. 9, 2014

(54) MARKETING MANAGEMENT SYSTEMS

(71) Applicant: Mark Verville, Henderson, NV (US)

(72) Inventor: Mark Verville, Henderson, NV (US)

(21) Appl. No.: 14/213,778

(22) Filed: Mar. 14, 2014

Related U.S. Application Data
(60) Provisional application No. 61/801,576, filed on Mar. 15, 2013.

(51) Int. Cl. G06Q 10/06

(52) U.S. Cl. CPC G06Q 10/06393
USPC 705/7.39

(57) ABSTRACT

A method for managing a performance-based award of a new distributorship within a network of distributorships. The method includes tracking a metric associated with an existing distributorship within the network of distributorships, comparing the metric with a corresponding metric threshold, determining whether the metric satisfies the corresponding metric threshold, and automatically allocating the new distributorship to the existing distributorship within the network of distributorships.

### CROSS-REFERENCE TO RELATED APPLICATIONS

This application claims the benefit of U.S. Provisional Application No. 61/801,576, filed on Mar. 15, 2014, which is incorporated by reference herein in its entirety.

### SUMMARY

Embodiments of a method are also described. In one embodiment, the method is a method for managing a performance-based award of a new distributorship within a network of distributorships. The method includes tracking a metric associated with an existing distributorship within the network of distributorships, comparing the metric with a corresponding metric threshold, determining whether the metric satisfies the corresponding metric threshold, and automatically allocating the new distributorship to the existing distributorship within the network of distributorships Other embodiments of the method are also described.

Embodiments of a system are described. In one embodiment, the system is a storage device to store data. The data includes a metric associated with an existing distributorship in a network of distributorships and a metric threshold which specifies a qualification parameter for the existing distributorship to qualify for an award of another distributorship. The system also includes a processor coupled to the storage device, the processor to compare the stored metric with the stored metric threshold to determine whether the existing distributorship qualifies for the award of the other distributorship. The system also includes a communication engine coupled to the processor, the communication engine to send a notification to a contact for the existing distributorship to announce the status of the award of the other distributorship. Other embodiments of the system are also described.

Embodiments of a computer program product are described. In one embodiment, the computer program product includes a computer readable storage medium which stores instructions thereon that, when executed by a computer processing device, are configured to cause the computer processing device to perform operations. The operations include comparing a metric with a corresponding metric threshold, wherein the metric represents a status of a first distributorship within a network of distributorships, and the metric threshold represents a qualification level for the first distributorship to receive an award distributorship. The operations also include executing an algorithm to generate an award determination whether to award the award distributorship to the first distributorship. Other embodiments of the computer program product are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a computer processing device for use in managing a distributorship network.

FIG. 2 depicts a schematic block diagram of a one embodiment of a distributorship manager that may be implemented in the computer processing device of FIG. 1.

FIG. 3 depicts a schematic block diagram of one embodiment of an electronic data storage device to store distributorship and metrics data structures within the computer processing device of FIG. 1.

FIG. 4 depicts a schematic block diagram of one embodiment of a distributorship deployment arrangement which may be facilitated by the distributorship manager of FIG. 2.

FIG. 5 depicts a schematic block diagram of another embodiment of a distributor deployment arrangement which may be facilitated by the distributorship manager of FIG. 2.

FIG. 6 depicts a schematic block diagram of one embodiment of a pay-it-forward (PIF) process which may be facilitated by the distributorship manager of FIG. 2.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Many of the functional units described in this specification have been labeled as modules, or equivalent functional units, in order to more particularly emphasize their implementation independence. Modules are at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented using software, stored on a physical storage device (e.g., a computer readable storage medium), for execution by various types of processors. Reference to a computer readable storage medium may take any physical form capable of storing machine-readable instructions, at least for a time in a non-transient state, on a digital processing apparatus. Examples of a computer-readable storage medium include, but are not limited to, a semiconductor or solid state memory, magnetic tape, a removable computer diskette, a random access memory (RAM), a read-only memory (ROM), a Bernoulli drive, a magnetic disk, flash memory, integrated circuits, or other digital processing apparatus memory device, and an optical disk. Current examples of optical disks include a compact disk with read only memory (CD-ROM), a compact disk with read/write (CD-R/W), and a digital video disk (DVD).

An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices which are referred to herein as computer readable media and/or electronic data storage devices.

In some embodiments, the software portions are stored in a non-transitory state such that the software portions, or representations thereof, persist in the same physical location for a period of time. Additionally, in some embodiments the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM) which can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of embodiments of the invention may be combined in any suitable manner in one or more embodiments. In the following description, numerous specific details are provided, such as examples of programming, software modules (stored on a physical device), user selections, network transactions, database queries, database structures, hardware modules, hardware circuits, hardware chips, etc., to provide a thorough understanding of embodiments of the invention. One skilled in the relevant art will recognize, however, that embodiments of the invention may be practiced without one or more of the specific details, or with other methods, components, materials, and so forth. In other instances, well-known structures, materials, or operations are not shown or described in detail to avoid obscuring aspects of the invention.

The schematic flow chart descriptions and/or diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While many embodiments are described herein, at least some of the described embodiments relate to a program for managing marketing distributorship channels. For convenience, some embodiments of this management system are referred to herein as Simplicity, or the Simplicity Program. In some embodiments, the Simplicity Program blends together charitable giving, education/training, and direct marketing. In many ways, the Simplicity Program simplifies traditional network marketing models by coupling a charitable donation with a revenue stream. Through automated processes, the charitable donation provides conditionally gifted distributorships and business kits for people interested in the business. These conditionally gifted distributorships are also referred to herein as distributorship reservations. General or specific algorithms may be implemented within these automated processes in order to customize how the conditionally gifted distributorships or reservations are calculated, generated, and allocated within a network of distributorships.

Embodiments of the Simplicity Program facilitate one or more benefits compared with traditional network marketing programs. In some embodiments, the Simplicity Program alleviates the monetary buy-in from individuals by applying credits (of any kind) from a corresponding donation to supply the distributorship and business kit. This may allow some individuals to participate and launch a successful business who otherwise would not have the opportunity to do so. Additionally, in some embodiments, the Simplicity Program may allow non-traditional participants to have participation opportunities that traditionally have not been taken advantage of. And embodiments of the Simplicity Program can accomplish these objectives which significantly helping charities, foundations, and other non-profit organizations through the establishment of ongoing donation streams.

Although there are various ways in which aspects of the Simplicity Program may be implemented, some examples are described below. In one example, a donor chooses a charity or foundation to be designated as a beneficiary organization. The donor also chooses a donation amount. The donation amount is used to purchase distributorships and product from a participating product supplier. In some embodiments, distributorships and product are given to the beneficiary organization through the establishment of a beneficial business center (BBC), which is a special-purpose entity (e.g. an LLC set up for a specific organization) for the benefit of the beneficiary organization. In some embodiments, products can be separated from the distributorships and given to the designated beneficiary organization. In some embodiments, distributorships are granted based on predetermined qualifications. In some embodiments, fraternities, sororities, or other organizations whose objectives align with the donor and/or the designated beneficiary organization may participate in the deployment method to drive additional volume within the network of distributorships.

While the income generated through the network marketing efforts will benefit all distributor levels, it should be noted that at least one distributorship is established specifically for the direct benefit of the designated beneficiary organization. The BBC holds the distributorship on behalf of the designated beneficiary organization and is independently managed so that some or all of the income to the BBC distributorship is passed to the designated beneficiary organization. In other words, the BBC controls the movement of product and distributorships for the donor or sponsoring company. The BBC also controls the distribution of charitable funds and revenue created for the benefit of the designated beneficiary organization. This provides an ongoing donation stream for the designated beneficiary organization that increases with the success of the network marketing channels.

As described herein, the Simplicity Program simplifies traditional network marketing models by associating the revenue stream directly with ongoing charitable donations. Many people interested in making tax-deductible, charitable donations can position themselves for the momentum phase of the income stream. For example, profitable professionals and executives who plan to make charitable donations can give their donation to a charity, foundation, or another non-profit organization and receive a complete or partial tax benefit.

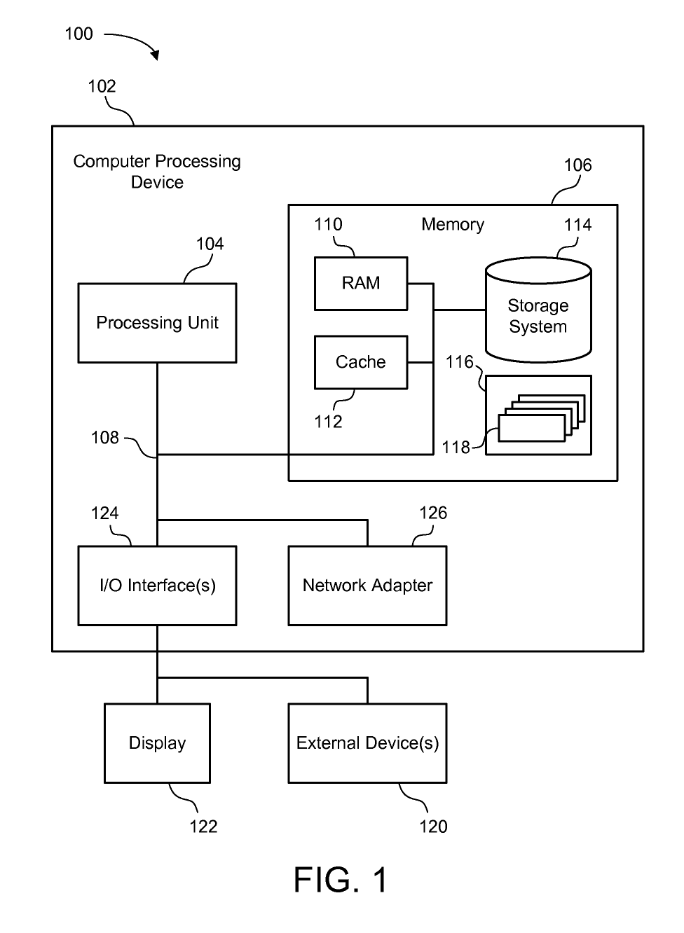

FIG. 1 depicts a schematic diagram of one embodiment of a computer system 100 for implementation of one or more aspects of the functionality described herein. The illustrated computer system 100 is only one example of a suitable computer architecture and is not intended to suggest any limitation as to the scope of use or functionality of embodiments of the invention described herein. Regardless, the computer system 100 is capable of being implemented to performing any or all of the functionality set forth hereinabove.

The depicted computer system 100 includes a computer processing device 102, which is operational with numerous other general purpose or special purpose computing system environments or configurations. Examples of well-known computing systems, environments, and/or configurations that may be suitable for use with computer system/server 102 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer processing device 102 may be described in the general context of computer system-executable instructions, such as program modules, being executed by a computer system. Generally, program modules may include routines, programs, objects, components, logic, data structures, and so on that perform particular tasks or implement particular abstract data types. Embodiments of the computer processing device 102 may be practiced locally, remotely, or in distributed cloud computing environments where tasks are performed by remote processing devices that are linked through a communications network. In a distributed cloud computing environment, program modules may be located in both local and remote computer system storage media including memory storage devices.

In one embodiment, the computer processing device 102 includes components and functionality typical of a general-purpose computing device. The components of the computer processing device 102 may include, but are not limited to, one or more processors or processing units 104, a system memory 106, and a bus 108 that couples various system components including the system memory 106 to the processor 104.

The bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer processing device 102 typically includes a variety of computer system readable media (also referred to as computer readable media and/or computer usable media). Such media may be any available media that is accessible by the computer processing device 102. Embodiments of the computer readable media may include one or more of the following types of media: volatile and non-volatile media, removable and non-removable media.

The system memory 106 can include computer system readable media in the form of volatile memory, such as random access memory (RAM) 110 and/or cache memory 112. The computer processing device 102 may further include other removable/non-removable, volatile/non-volatile computer system storage media. By way of example only, a storage system 114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 108 by one or more data media interfaces. As will be further depicted and described below, the memory 106 may include at least one program product having a set (e.g., at least one) of program modules that are configured to carry out the functions of embodiments of the invention.

In some embodiments, a program/utility 116, having a set (at least one) of program modules 118, is stored in the memory 106. The program modules 118 generally carry out one or more of the functions and/or methodologies of the embodiments described herein. The memory 106 also may store an operating system, one or more application programs, other program modules, and/or program data. Each of the operating system, one or more application programs, other program modules, and program data or some combination thereof, may include an implementation of a personal computer and/or networking environment.

The computer processing device 102 may also communicate with one or more external devices 120 such as a keyboard, a pointing device, a display 122, etc.; one or more devices that enable a user to interact with the computer processing device 102; and/or any devices (e.g., network card, modem, etc.) that enable the computer processing device 102 to communicate with one or more other computing devices. Such communication can occur via input/output (I/O) interfaces 124. Additionally, the computer processing device 102 can communicate with one or more networks such as a local area network (LAN), a general wide area network (WAN), and/or a public network (e.g., the Internet) via a network adapter 126. As depicted, the network adapter 126 communicates with the other components of the computer processing device 102 via the bus 108. It should be understood that, although not shown, other hardware and/or software components could be used in conjunction with embodiments of the computer processing device 102. Examples, include, but are not limited to: microcode, device drivers, redundant processing units, external disk drive arrays, RAID systems, tape drives, and data archival storage systems, etc.

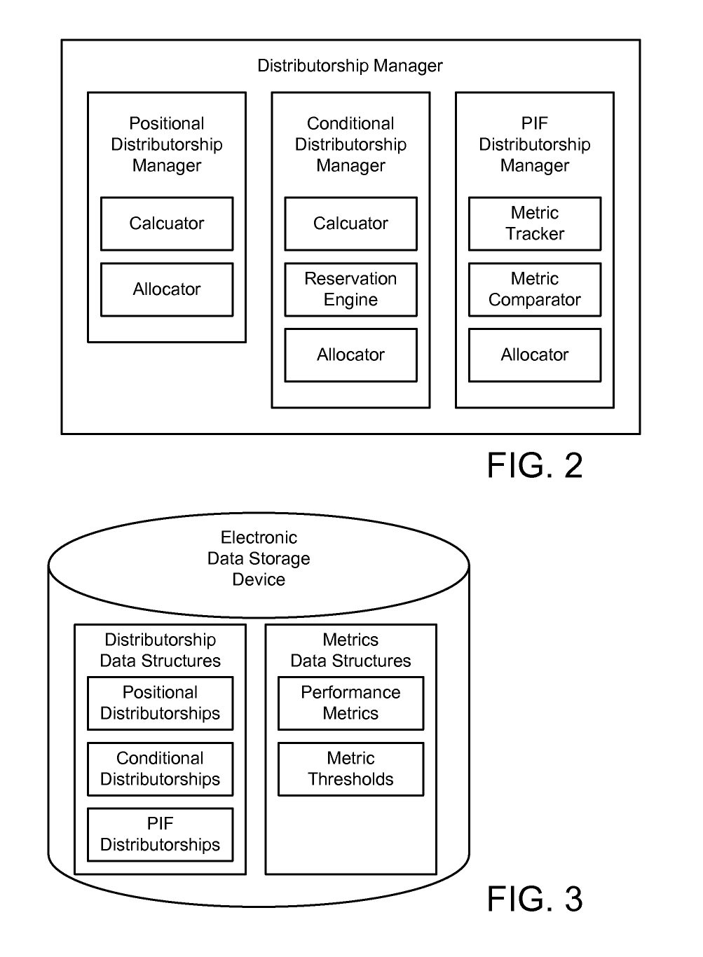

FIG. 2 depicts a schematic block diagram of a one embodiment of a distributorship manager that may be implemented in the computer processing device of FIG. 1. In particular, functionality of the distributorship manager may be implemented through execution of instructions by the processing unit.

In general, the distributorship manager oversees the automated management of the various distributorships within a network of distributorships. All of the distributorships of a single leg, multiple legs, or all of the legs within a distributorship network may be managed by the distributorship manager.

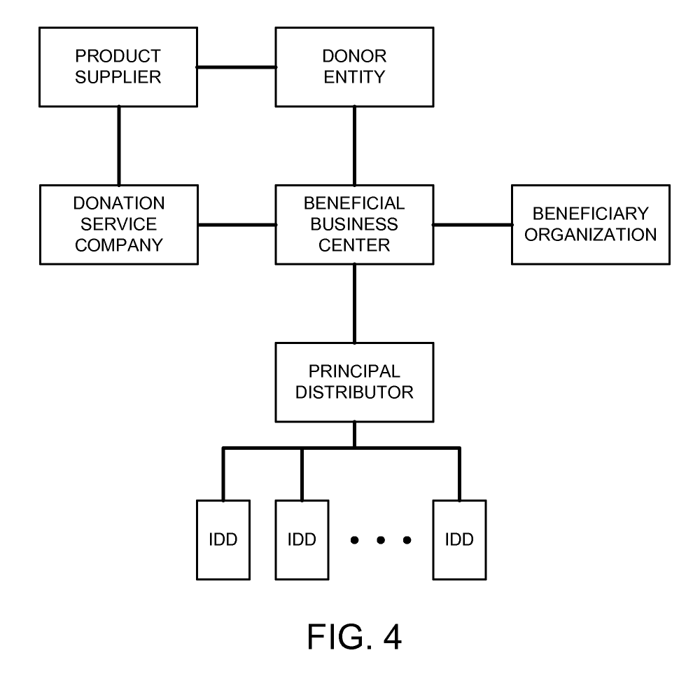

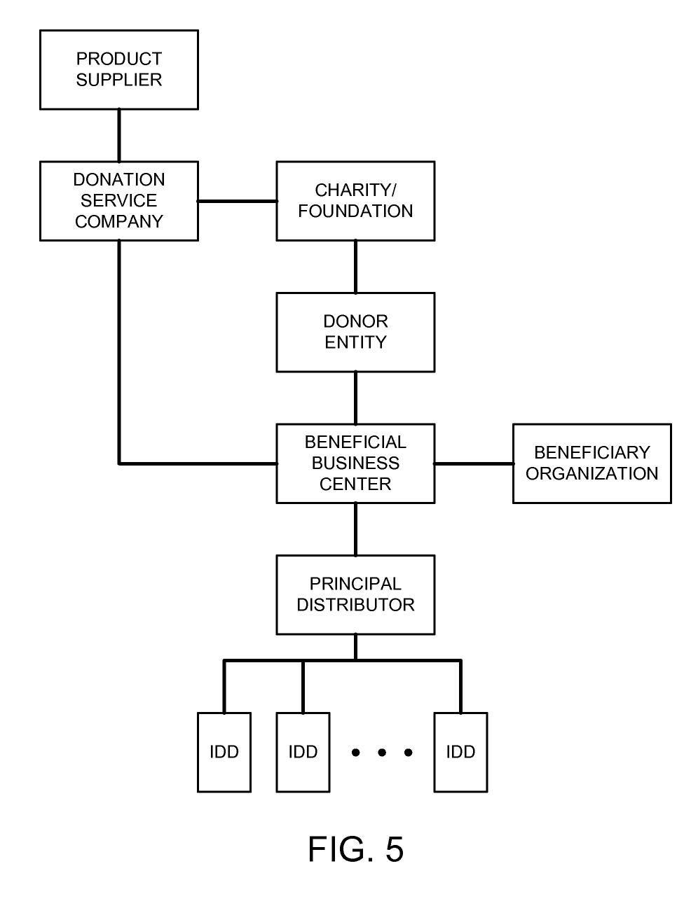

The illustrated distributorship manager includes a positional distributorship manager, a conditional distributorship manager, and a pay-it-forward (PIF) distributorship manager. These different types of managers may manage certain aspects of different categories of distributorships. Generally, the positional distributorships refer to top-level distributorships established when a new donation is received and a corresponding leg of the network is initialized. With reference to FIGS. 4 and 5, the donor entity distributorship, the BBC distributorship, and the principal distributor distributorship may be designated as positional distributorships. The conditional distributorships refer to lower-level distributorships below the positional distributorships. These conditional distributorships may be reserved at the time the positional distributorships are initialized and subsequently gifted to individuals or entities upon certain conditions of performance by the recipient individuals or entities. With reference to FIGS. 4 and 5, the initial deployment distributorships (IDDs) may be designated as conditional distributorships. However, the designations of positional distributorships and conditional distributorships are for convenience only and are not limiting to the ways in which operations within the distributorship manager might be implemented.

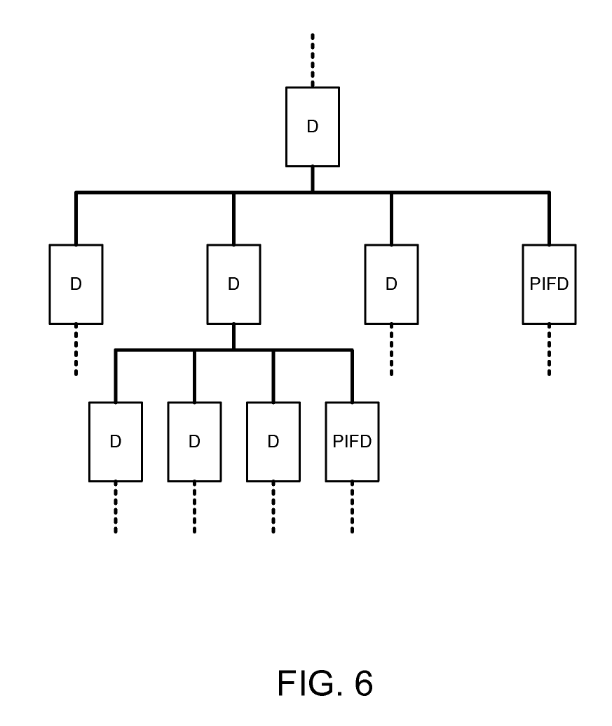

The PIF distributorships generally refer to distributorships that are created upon the satisfaction of one or more performance metrics by another distributorship. As one example, with reference to FIG. 6, a higher-level distributorship may be awarded with a PIF distributorship upon establishing some threshold number of lower-level distributorships. In the example illustrated in FIG. 6, each level of distributorship may be awarded one PIF distributorship for every three additional distributorships that are established. However, the number of distributorships established is only one example of a metric that might be tracked and utilized. Other embodiments may utilize another performance metric, or a combination of performance metrics, in order to determine an award of a PIF distributorship to a higher-level distributorship.

Referring back to FIG. 2, in one embodiment, the positional distributorship manager includes a calculator and an allocator. The calculator may calculate the number of positional distributorships that are established in response to a particular donation from a donor. The potential number of positional distributorships may be limited by the total donation amount divided by the cost for each distributorship. In the example of FIGS. 4 and 5, three positional distributorships are established—one for the donor; one for the BBC, and one for the principal distributor who will manage allocation of the conditional distributorships to the IDDs. The allocator of the positional distributorship manager may record details of the allocation of each positional distributorship to the corresponding entities.

Similar to the positional distributorship manager, the conditional distributorship manager also includes a calculator and an allocator. The calculator may calculate the number of conditional distributorships that are established in response to the donation from the donor. In some embodiments, the number of conditional distributorships available is the remaining number of distributorships that are possible (based on the total donation amount divided by the cost of each distributorship) minus the number of distributorships that are allocated as positional distributorships. In one example, if the donation amount is $1000, and the cost for each distributorship is $100, and there are three positional distributorships allocated, then the remaining number of conditional distributorships is seven. In some embodiments, these calculations may be altered by administrative or other costs, but the general approach may be substantially similar.

The illustrated conditional distributorship manager also includes a reservation engine. In some embodiments, the calculated number of conditional distributorships are not allocated immediately upon initial deployment. Rather, the reservation engine may track reservations, generally, or for specific conditional recipients, for the conditional distributorships that are not allocation upon initial deployment. Then, once instructed, the allocator can record details of the subsequent allocation of each conditional distributorship to the corresponding entity.

The PIF distributorship manager may perform similar functions as the positional and/or the conditional distributorship managers. Additionally, the illustrated PIF distributorship manager includes a metric tracker, a metric comparator, and an allocator. In one embodiment, the metric tracker monitors or tracks a performance metric associated with a particular distributorship. In other embodiments, the metric tracker may monitor or track a plurality of performance metrics associated with a particular distributorship. Periodically, or in response to an automated or manual trigger event, the metric comparator compares the stored metric(s) with stored metric threshold(s) to determine whether the existing distributorship qualifies for the award of a PIF distributorship. In this way, the metric threshold specifies a qualification parameter for the existing distributorship to qualify for an award of another distributorship. The allocator can record details of any PIF distributorship allocations.

FIG. 3 depicts a schematic block diagram of one embodiment of an electronic data storage device to store distributorship and metrics data structures within the computer processing device of FIG. 1. Although a specific number of data structures are shown and described, other embodiments may include another aggregate number of data structures, or another number of data structures for a particular type of data. Additionally, the type of data structure used to store a particular type of data should not be limited in any embodiments—any available type of data structure may be used to store any of the different sets of data.

The distributorship data structures include positional distributorships, conditional distributorships, and PIF distributorships. Each of these data structures may be managed by the corresponding distributorship manager shown in FIG. 2 and described above.

The metrics data structures include performance metrics data structures to store one or more metrics observed or tracked for one or more distributorships (or groups of distributorships). The metric thresholds data structure may store thresholds corresponding to different metrics, combinations of metrics, combinations of metrics with particular distributorships or distributorship levels, and so forth.

FIG. 4 depicts a schematic block diagram of one embodiment of a distributorship deployment arrangement which may be facilitated by the distributorship manager of FIG. 2. As explained above, the donor may make a donation which results in allocation of multiple positional distributorships. In the illustrated example, the positional distributorships include the donor entity distributorship, the BBC distributorship, and the principal distributor distributorship. Additionally, the initial donation established reservations or allocations for the initial deployment distributorships (IDDs).

Products or services are provided by product supplier to the different levels of distributorships for marketing and commercialization purposes. As explained above, the BBC distributorship may be managed for the benefit of the beneficiary organization. For example, the BBC may supply products from the product supplier to the beneficiary organization. Also, the BBC may electronically transfer funds (e.g., commissions) to the beneficiary organization as an ongoing donation stream.

In one embodiment, a donation service company (or charitable donation service company) also helps to manage the processes among the product supplier, the donor, and the beneficial business center. Specifically, the donation service company may manage certain aspects of the allocation of distributorships, as well as the administrative processing of tasks associated with the distributorships within the corresponding leg of the distributorship network.

In some embodiments, the principal distributor establishes the qualification criteria for the IDDs to ensure that legal compliance rules are satisfied and IDDs are initialized for the further benefit of the designated beneficiary organization.

FIG. 5 depicts a schematic block diagram of another embodiment of a distributor deployment arrangement which may be facilitated by the distributorship manager of FIG. 2. In the illustrated example, the donor may make the initial donation through a managed charity, foundation, or other non-profit organization.

Additionally, the donation may be managed in part by the donation service company, which may be a separate non-profit organization.

Although many embodiments and arrangements may be implemented to realize the benefits of the system described herein, in one embodiment a method for establishing a deployment team of distributors includes receiving a donation amount on behalf of a donor. The method also includes allocating a plurality of positioned distributorships to a corresponding plurality of entities in response to the donation. The method also includes calculating a number of conditional distributorships available based on at least a portion of the donation. The method also includes electronically storing a reservation for each of the conditional distributorships. In further embodiments, the method also includes processing an instruction to allocate one of the conditional distributorships to a new distributor, and electronically updating the reservation for the corresponding conditional distributorship to reflect the allocation of the conditional distributorship. In some embodiments, the method also includes calculating a number of the positioned distributorships the based on an instruction from the donor. In some embodiments, the process of allocating the plurality of positioned distributorships to the corresponding plurality of entities also includes allocating one of the positioned distributorships to a beneficial business center (BBC), which acts as a representative of a beneficiary organization to facilitate electronic fund transfers on behalf of the beneficiary organization. Other embodiments include additional functionality, and corresponding systems and software may be implemented for aspects of each embodiment.

FIG. 6 depicts a schematic block diagram of one embodiment of a pay-it-forward (PIF) process which may be facilitated by the distributorship manager of FIG. 2. As explained briefly above, the PIF distributorship may be awarded to a higher-level distributorship as recognition of performance at a certain level.

Although many embodiments and arrangements may be implemented to realize the benefits of a PIF award system, in one embodiment a method for managing a performance-based award of a new distributorship within a network of distributorships includes tracking a metric associated with an existing distributorship within the network of distributorships. The method also includes comparing the metric with a corresponding metric threshold. The method also includes determining whether the metric satisfies the corresponding metric threshold. The method also includes automatically allocating the new distributorship to the existing distributorship within the network of distributorships. In further embodiments, the method also includes storing data representative of a state of the metric at a point in time in an electronic data storage device, and storing updated data in the electronic data storage device. The updated data is representative of a subsequent state of the metric at a subsequent point in time. In some embodiments of the method the metric is a count of distributorships directly associated with the existing distributorship, and comparing the metric involves comparing the count with a distributorship count threshold which specifies a number of distributorships to be associated with the existing distributorship. Other embodiments include additional functionality, and corresponding systems and software may be implemented for aspects of each embodiment.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for managing a performance-based award of a new distributorship within a network of distributorships, the method comprising:
tracking a metric associated with an existing distributorship within the network of distributorships;
comparing the metric with a corresponding metric threshold;
determining whether the metric satisfies the corresponding metric threshold; and
automatically allocating the new distributorship to the existing distributorship within the network of distributorships.

2. The method of claim 1, further comprising:
storing data in an electronic data storage device, wherein the data is representative of a state of the metric at a point in time; and
storing updated data in the electronic data storage device, wherein the updated data is representative of a subsequent state of the metric at a subsequent point in time.

3. The method of claim 1, wherein the metric comprises a count of distributorships directly associated with the existing distributorship, and comparing the metric comprises comparing the count with a distributorship count threshold which specifies a number of distributorships to be associated with the existing distributorship.

4. A system comprising:
a storage device to store data, wherein the data comprises:
a metric associated with an existing distributorship in a network of distributorships; and
a metric threshold which specifies a qualification parameter for the existing distributorship to qualify for an award of another distributorship;
a processor coupled to the storage device, the processor to compare the stored metric with the stored metric threshold to determine whether the existing distributorship qualifies for the award of the other distributorship; and
a communication engine coupled to the processor, the communication engine to send a notification to a contact for the existing distributorship to announce the status of the award of the other distributorship.

5. A computer program product comprising:
a computer readable storage medium which stores instructions thereon that, when executed by a computer processing device, are configured to cause the computer processing device to perform operations, wherein the operations comprise:
comparing a metric with a corresponding metric threshold, wherein the metric represents a status of a first distributorship within a network of distributorships, and the metric threshold represents a qualification level for the first distributorship to receive an award distributorship; and
executing an algorithm to generate an award determination whether to award the award distributorship to the first distributorship.
